(19) United States
(12) Patent Application Publication
(10) Pub. No.: US 2010/0217570 A1
(43) Pub. Date: Aug. 26, 2010

(54) Method for Simulating the Failure Rate of an Electronic Equipment Due to Neutronic Radiation

(76) Inventor: Stéphane Charruau, Eysines (FR)

Correspondence Address: LARIVIERE, GRUBMAN & PAYNE, LLP, 19 UPPER RAGSDALE DRIVE, SUITE 200, MONTEREY, CA, 93940, US

(21) Appl. No.: 12/519,679

(22) PCT Filed: Dec. 20, 2007
(86) PCT No.: PCT/EP2007/064328

§ 371 Date: Aug. 24, 2009

(30) Foreign Application Priority Data
Dec. 21, 2006 (FR) 0611212

(51) Int. Cl. G06G 7/62; G06F 17/10; G06F 17/11

(52) U.S. Cl. 703/2; 703/13

(57) ABSTRACT

The field of the invention is that of the design and use of electronic systems subjected to an ionizing radiation environment of natural or artificial origin. The invention relates to a method for simulating the failure rate of electronic equipment subjected to atmospheric neutron radiation of natural origin. From parameters giving the geographic location of the equipment, which are longitude, latitude and altitude, and from a knowledge of the grid width of the transistors constituting the electronic components of the equipment, this width being representative of the technology employed, the method makes it possible to determine the anticipated failure rate of the equipment due to neutron irradiation.

### PRIORITY CLAIM

This application claims priority to PCT Patent Application Number PCT/EP2007/064328, entitled Method for Simulating the Failure Rate of an Electronic Equipment Due to Neutronic Radiation, filed on Dec. 20, 2007.

### BACKGROUND OF THE INVENTION

1. Field of the Invention

The field of the invention is that of the design and use of electronic systems subjected to an ionizing radiation environment of natural or artificial origin.

The impact of high-energy cosmic rays on atoms of the upper atmosphere and solar eruptions brings about the appearance of streams of protons, muons, electrons and neutrons in the earth's atmosphere. Only neutrons present a problem. In point of fact, these high-energy neutrons pass easily through matter and in particular electronic and computer systems. If their energy is sufficient, these neutrons may bring about the disintegration of the atoms of various electronic components. This disintegration is accompanied by an emission of charged elements including electrons. These charged elements may then either disturb the operation of the electronic system or finally damage it.

2. Description of the Prior Art

The highest exposure of electronic systems to ionizing radiation of natural origin is encountered in aircraft flying at a high altitude. Thus, the mean neutron flux passes from 10,000 particles/cm²/hour at 30 000 feet to 10 particles/cm²/hour at sea level. This phenomenon is all the more serious since the satisfactory operation of onboard electronic systems, also called avionic systems, is strategic for ensuring the safety of the aircraft and its passengers, in particular during long-haul commercial flights where the altitude and duration of the flight accentuates this phenomena all the more.

This problem has been known for several decades and has received various solutions. As regards equipment, malfunctions brought about by neutron flux have been reduced either by duplicating the systems, or by using more robust technologies such as SOI technology (acronym signifying Silicon On Insulator), a technology for producing microprocessors consisting of inserting a layer of insulating material between each silicon oxide layer so as to reduce leakage currents that are the source of malfunction. Materials such as boron have also been eliminated from the manufacture of components. Solutions as regards software have also been provided by making use, for example, of the principle of data redundancy achieved by their repetition and an analysis of their coherence.

However, these solutions present a certain number of disadvantages. Data redundancy brings about a loss in processing rapidity and their multiplication brings about greater bulk and cost of systems. Recourse to technological solutions such as the use of SOI substrates does not eliminate the number of temporary or permanent anomalies. It simply reduces the risk of permanent destructive anomalies. As regards the elimination of boron, this only suppresses the effects of neutrons called thermal neutrons and those of other particles such as alpha particles. The disturbing impact of neutrons of cosmic or solar origin is scarcely prevented at all.

On the other hand, these solutions are employed independently of any simulation of nuclear interaction and of any numerical model simulating the behavior of semiconductors subjected to nuclear bombardment. These codes, such as the TALYS and ALICE codes exist but can only be used by specialists in a fundamental research environment. They are not made in order to be employed in an industrial context.

### SUMMARY OF THE INVENTION

The object of the invention is to provide a method for simulating the failure rate of electronic equipment subjected to atmospheric neutron radiation of natural origin that is simple to put into operation, that is to say in a manner applicable with spreadsheets currently employed in office data processing. This method may have various technical applications. By simulating the failure rate, it makes it possible to anticipate equipment failures, to develop codes for detecting errors making it possible to achieve the desired reliability levels, to anticipate future failure rates due to technological developments and in particular to the miniaturization of components.

More precisely, the object of the invention is a method for simulating the failure rate of electronic equipment disposed at a known latitude, longitude and altitude and subjected to atmospheric neutron radiation of natural origin, said equipment having electronic components on a silicon substrate including transistors of which the technology is determined by a known grid width, said method comprising the following steps:
Calculating the number of incident atmospheric neutrons per unit area and per unit time as a function of the altitude, latitude and longitude within a given energy spectrum;
Calculating the critical energy of a neutron sufficient to change the state of the transistor, said energy being a function of the of the grid width and the depth at which said neutron strikes the nucleus of an atom under the active surface of the electronic component;
Calculating the sensitive volume of a transistor within which a neutron having an energy equal to or greater than the critical energy can change the state of this transistor;
Calculating the probability of an incident neutron colliding with a silicon nucleus as a function of the depth under the active surface of the electronic component;
Calculating the number of collisions between incident neutrons coming from the interactions of cosmic rays with atoms of the upper atmosphere per unit area and per unit time with silicon nuclei belonging to the sensitive volume of a transistor as a function of:
   the number of neutrons having an energy equal to or greater than the critical energy;
   the volume sensitive to neutron interactions in the transistor capable of bringing about a change of state of the transistor;
   the probability of an incident neutron colliding with a silicon nucleus;
Calculating the projected failure rate per hour as a function of:
   the probability of an incident neutron colliding per unit area and per unit time with a silicon nucleus belonging to the sensitive volume;
   the number of electronic components.

Advantageously, the number of incident atmospheric neutrons per unit area and per unit time is equal to the product:
of a first constant;
of a first exponential function of which the exponent depends on latitude and longitude;
of a second exponential function of which the exponent depends on altitude;
of a difference between two error functions, functions of the boundaries of the energy spectrum.

Advantageously, the second exponential function of which the exponent depends on the altitude A is of the Weibull law type, the exponent varying as a function of altitude to the expression:

$${( \frac{{K}_{A} - A}{{K}_{A}^{′}} )}^{{K}_{A}^{′}}$$

with K_{A}, K_{A}′ and K_{A}″ being the second, third and fourth constants.

Advantageously, the critical energy of a neutron is equal to the ratio between:
the product of a fifth constant multiplied by the blocking voltage multiplied by the critical charge;
an exponential function depending on the depth under the active surface of the electronic component.

Advantageously, the blocking voltage is a second degree polynomial that is a function of the grid width.

Advantageously, the critical charge is an exponential function dependent on the grid width.

Advantageously, the critical energy of a neutron is such that it produces electrical charges collected in the region of the source and of the drain sufficient to cause the logic state of the transistor to flip-flop within a period less than the life τ of these charges.

Advantageously, a sensitive volume is defined that is the volume in which the modulus of the electrical field due to the drain-source potential of the transistor is such that the electrical field may ensure the transport of electronic charges created by the impact of a neutron within a period less than the life of these charges subject to recombinations between them or with impurities of the semiconductor.

Advantageously, the geometrical forms of the source and of the drain of the transistor match those of hyperbolic cylinders so that they can be represented with the aid of the transformation according to:

$$χ = x + j z = \frac{Λ}{2} ( 1 + cosh ( ξ + j η ) )$$

$$j = \sqrt{- 1}$$

where x is the distance to the plane of the transistor source, z the depth under the active surface of the electronic component and Λ the grid width on the one hand and ξ and η being the elliptical coordinates, on the other hand. In this way, the geometrical forms of the source and drain are described by the equations η=cons tan te<π/2 (drain)>π/2 (source)

Advantageously, the modulus of the electrical field as a function of the blocking voltage V, of the distance x to the plane of the source of the transistor, of the depth z under the active surface of the electronic component and the grid width Λ has the following expression

$$\vert E ( ζ ) \vert = \frac{V ( Λ )}{Λ} \cdot \vert \frac{exp ( - \frac{ζ}{2} )}{sinh ζ} \vert$$

in which the complex variable ζ is defined from the elliptical coordinates (ξ, η) with ζ=ξ+jη and j=\sqrt{−1}

Advantageously, the volume sensitive to neutron interactions is defined as the elliptical domain where ξ, is less than ξ_{MAX} where ξ_{MAX} is the solution of the equation:

$${e}^{{ξ}_{MAX}} ( 1 - {e}^{- \frac{{ξ}_{MAX}}{2}} ) {( sinh {ξ}_{MAX} )}^{2} = 2 D \frac{{K}_{n}}{T} \frac{V ( Λ )}{Λ} τ$$

in which T is the absolute temperature, Kₙ the universal physical constant equal to the electron charge divided by twice the Boltzmann constant, D the diffusion constant of electrical charges and τ the life of the charges created by neutron impact, said volume having a maximum depth z_{MAX} equal to

$$\frac{Λ}{2} sinh {ξ}_{MAX} .$$

The invention applies notably to onboard equipment for an aircraft, said aircraft performing a flight of which the profile is defined by the latitudes and longitudes of the starting and arrival airports and by the altitude profile of the flight between said airports, the method then including a supplementary step consisting of calculating the mean failure rate as a function of said flight profile.

Advantageously, said equipment includes means for detecting and correcting errors due to failures of the equipment subjected to atmospheric neutron radiation, said means being dimensioned as a function of said failure rate calculated by means of a method according to the invention.

### BRIEF DESCRIPTION OF THE DRAWINGS

The invention will be better understood and other advantages will become apparent on reading the following description given in a non-limiting manner and by means of the appended figures, among which:

FIGS. 1 to 4 represent the scenario of an electronic failure due to the impact of a neutron;

FIG. 5 represents variations in the neutron flux as a function of the terrestrial latitude;

FIG. 6 represents variations in the neutron flux as a function of the terrestrial altitude;

FIG. 7 represents variations in the number of critical collisions between a neutron and a transistor as a function of the grid width of the transistor;

FIG. 8 represents variations in the number of critical collisions between a neutron and a transistor as a function of depth of the transistor grid.

FIG. 9 represents the electronic effect of the impact of a neutron on an MOS transistor.

### MORE DETAILED DESCRIPTION

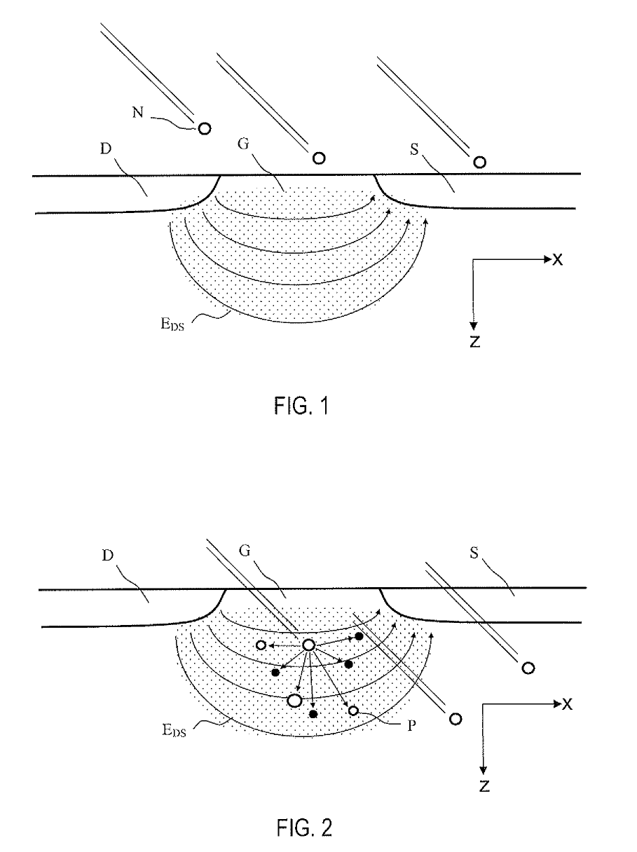

The physical phenomenon bringing about a failure or malfunction of a transistor is described in FIGS. 1 to 4.

In these figures, a transistor is represented of the field effect type conventionally used in digital electronics. These transistors are generally produced on a silicon substrate. It comprises a drain D, a grid G and a source S. An electric field E_{DS} exists between the drain and the source. This field is represented by curved field lines in FIGS. 1 to 4. As will be seen, two parameters of the transistor are fundamental for determining failures due to neutron flux. These are, on the one hand, the grid width Λ and, on the other hand, the depth z of the active zone of the transistor situated under the grid. In these figures, a reference (x, z) is shown. The x axis extends in the direction of the grid width and the z axis in the direction of the depth of the active zone.

In FIG. 1, the transistor is subjected to neutron bombardment composed of neutrons N. Each neutron has an energy E_{N}.

As indicated in FIG. 2, most of the neutrons pass through the transistor without causing damage. However, some neutrons strike the silicon atoms of the active zone situated under the grid and, if their energy is sufficient, bring about their disintegration. In this case, a burst of particles P is emitted.

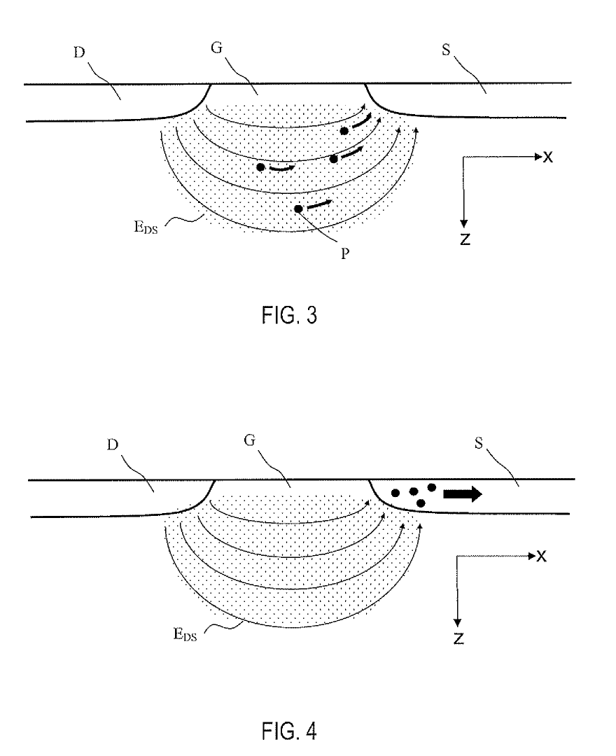

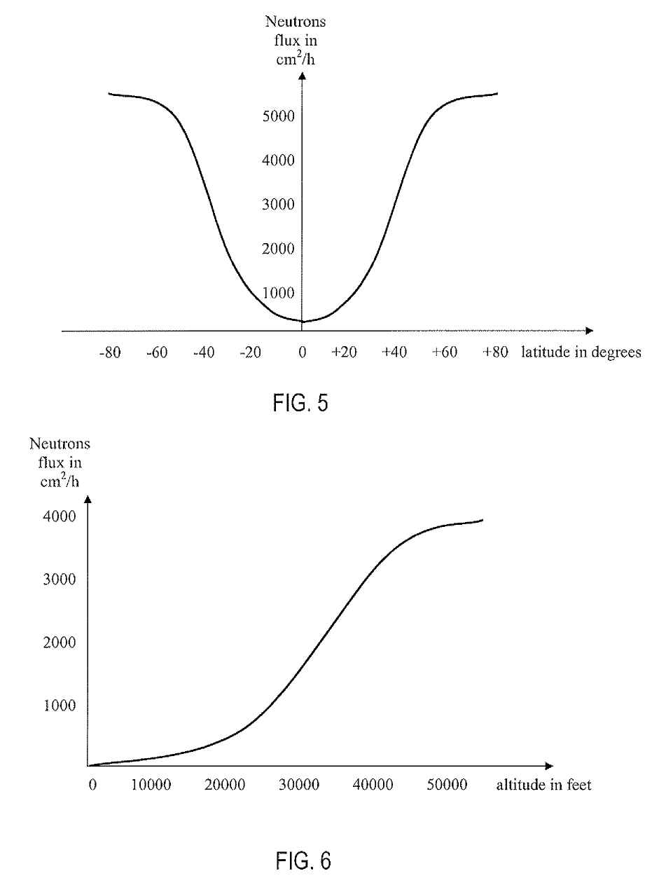

If the electric field is sufficient, the charged particles emitted are entrained towards the drain or the source of the transistor according to their polarity as indicated in FIG. 3.

This flux of charge particles is equivalent to an electric current. If this current is sufficient, it may bring about a change in state of the transistor, either from the passing state to the blocking state or conversely. In this case, the state of the binary data carried by the memory cell to which the transistor belongs may be modified.

The simulation method consists of quantifying, in a simple manner, that is to say in a manner applicable to spreadsheets currently used in office data processing, the various steps leading to a failure of the transistor.

The first step of the simulation method consists of determining, in a simple manner, the number of incident atmospheric neutrons N distributed within a given energy spectrum defined by the limit E_{N0} and E_{N1}, per unit area and per unit time as a function of the altitude A, of the latitude L and of the longitude l. Following a certain number of studies, the distribution of atmospheric neutrons in the atmosphere is known. In order to be able to make use of this data in a simple manner, it is however necessary to estimate it by means of a mathematical formula that can be easily employed, in particular in spreadsheets currently used in office data processing. The equation 1 below represents a very good approximation of the distribution of atmospheric neutrons in the atmosphere.

N_{E}_{_{N0}}_{-E}_{_{N1}}=K1·exp(f_{L}·f_{I})·(erf(f_{E}(E_{N1}))−erf(f_{E}(E_{N0})))·exp(−f_{A}) Equation 1

with K1 a constant having a value substantially equal to 20700 neutrons per cm² and per hour, the latitude L and longitude l being expressed in degrees, the altitude in feet, the energies E_{N} in MeV, the function erf representing the integral of the normal law, also called the error function,

and f_{L}, fₗ, f_{E} and f_{A} functions of latitude, longitude, altitude and energy verifying:

$$\begin{matrix}{f}_{L} = {K}_{L 1} \cdot {sin}^{2} ( \frac{2 π}{180} \cdot L ) - {K}_{L 2} \cdot {cos}^{2} ( \frac{π}{180} \cdot L ) & Equation 2 \\ {f}_{1} = 1 - {K}_{1} \cdot sin ( \frac{π}{180} \cdot ( 1 + 20 + 1 , 5 \cdot L ) ) & Equation 3 \\ {f}_{E} = {K}_{E} \cdot ln {E}_{N} - {K}_{E}^{′} & Equation 4 \\ {f}_{A} = {( \frac{{K}_{A} - A}{{K}_{A}^{′}} )}^{{K}_{A}^{″}} & Equation 5\end{matrix}$$

The terms in K being constants having a value substantially equal to:

K_{L1}=0.768 K_{L2}=3.13 Kₗ=0.410 K_{E}=0.12 337

K_{E}′=0.31653 K_{A}=55000 K_{A}′=26345 K_{A}″=2.3955

As an example, the curves 5 and 6 represent variations in the neutron flux for all the energy spectrum, on the one hand as a function of altitude at constant longitude and latitude and, on the other hand, as a function of latitude at constant longitude and altitude.

The second step of the simulation method consists of determining the critical energy Ω_{C} a neutron sufficient to create a critical charge capable of changing the state of a transistor. It is demonstrated that said energy is a function of the grid width Λ and the depth z under the active surface active of the electronic component.

More precisely, in a first approach, the relationship linking Ω_{C} to these parameters is as follows:

$${Ω}_{C} = \frac{{K}_{Ω 1} \cdot V ( Λ ) \cdot Γ ( Λ )}{1 - {K}_{Ω 2} \cdot exp ( {K}_{Ω 3} \cdot ) exp ( {K}_{Ω 4} \cdot exp ( - {K}_{Ω 5} \cdot z ) )} \qquad Equation 6$$

V(Λ) represents the blocking potential in volts as a function of grid width Λ. A good approximation may be obtained by means of the following formula:

V(Λ)=K_{V}+K_{V}′·Λ−K_{V}″·Λ² Equation 7

Γ(Λ) represents the critical charge Γ in the grid or channel of the transistor beyond which the transistor is liable to change state. Γ(Λ) is expressed in femtofarads. It is associated with the grid width Λ by the relationship:

Γ(Λ)=exp(K_{Γ}·exp(K_{Γ}′Λ) Equation 8

the terms in K being constant having a value substantially equal to:

K_{Ω}1=11.562×10⁻³ K_{Ω}2=0.368 K_{Ω}3=0.8668 K_{Ω}4=0.133

K_{Ω}5=0.405 K_{V=0.3211} K_{V}′=13.438 K_{V}″=12.125

K_{Γ=0.91702} K_{Γ}′=8.6641

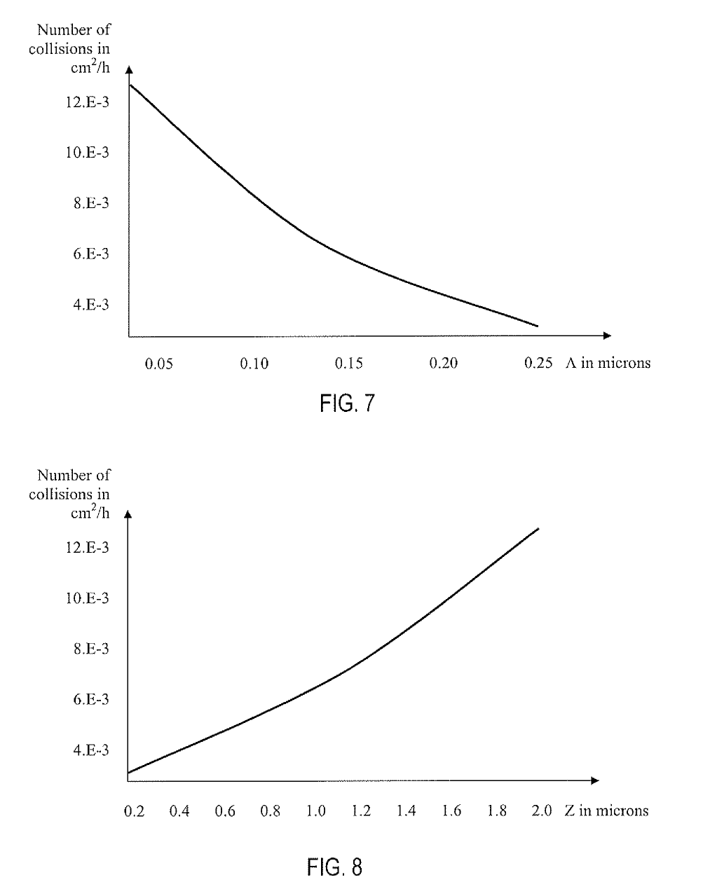

It is found that the smaller the grid width, the lower the critical energy Ω_{C}. Consequently, the lower the grid width, the higher the number of atmospheric neutrons having an energy greater than or equal to the critical energy, in this way increasing the number of critical collisions per unit area. As an example, FIG. 7 shows the number of critical collisions as a function of grid width Λ, all other things being equal.

An improvement in the method according to the invention lies in the replacement of the calculation of critical energy Ω_{C} based on the critical charge by a calculation based on the critical current between the drain and the source of the transistor likely to cause the logic state thereof to flip-flop. This approach rests on equations 24 to 30 of the third step described below.

The third step of the simulation method consists of determining the sensitive volume of a transistor in which a neutron having an energy equal to or greater than the critical energy can create the critical charge. This volume corresponds to the part of the active zone of silicon situated under the grid of the transistor in which electron-hole pairs created by incident neutrons are collected effectively before they are recombined by the two-dimensional electric field E present between the drain and the source. This volume is substantially characterized by a depth of the active zone and an area linked to the dimensions of the drain-source channel. Outside this volume, neutrons are without effect. Determination of this volume then proceeds through a knowledge of the electrical field. The expression of the modulus of the two-dimensional electrical field E(x,z) due to the blocking voltage V(Λ) in any point of the abscissa x in the drain-source axis of the transistor having a grid width Λ and a depth z under the grid is obtained in elliptical coordinates adapted to the geometry of the drain-source of the transistor according to standard transformation method well known in electrostatics. This expression is:

$$\vert E ( ζ ) \vert = \frac{V ( Λ )}{Λ} \cdot \vert \frac{exp ( - \frac{ζ}{2} )}{sinh ζ} \vert \qquad Equation 9$$

The complex variable ζ is defined from the elliptical coordinates (ξ, η)

ζ=ξ+jη with j=\sqrt{−1} Equation 10

and the standard transformation making it possible to pass from Cartesian coordinates (x,z) to elliptical coordinates (ξ, η) adapted to the geometry of the drain-source channel of the transistor and to the conventional operating model of a transistor in MOS technology is written:

$$𝒳 = x + j z = \frac{Λ}{2} ( 1 + cosh ζ ) \qquad Equation 11$$

Knowing the value of the modulus of the two-dimensional electrical field E expressed in the form of the modulus of an analytical function according to equation 9, it is then a simple matter to determine the area and depth of the sensitive volume. In point of fact, the collection of electron-hole pairs by the electrical field in the drain-source channel of a transistor is satisfactorily described by the three-dimensional diffusion equation of charged particles in a two-dimensional electrical field “E(x,z)” which gives the volume density “n(x,z,y)” of particles at any point of the channel “(x,z,y)”:

$$Δ n + \frac{2 {K}_{n}}{T} ∇ ( En ) - \frac{1}{D} \frac{\partial n}{\partial t} = 0 \qquad Equation 12$$

where Δ is the Laplace operator, ∇ the “divergence” operator, ∂ is the symbol for partial differentiation, t is the time, T is the absolute temperature, Kₙ is a universal physical constant equal to the charge of the electron divided by twice the Boltzmann constant and of which an approximate value has the value of 5797 in SI units, and D is the diffusion constant of the electrical charges.

In order to determine the area and depth of the sensitive volume, it is necessary to solve the equation giving “n” as a function of ζ=ξ+jη with j=\sqrt{−1} and of “y” denoted hereinafter under the name “reference”.

By changing the density function governed by the equation below,

$$n ( x , z , y ) = \hat{n} ( x , z , y ) exp ( - \frac{{K}_{n}}{T} V ( x , y , z ) ) \qquad Equation 13$$

where V is the potential of the electrical field, T the absolute temperature that is assumed to be uniform, Kₙ being the universal physical constant already encountered, the three-dimensional diffusion equation of the density n of the charged particles is brought to a three-dimensional equation of the density \hat{n}, an equation of the Schrödinger type known in quantum mechanics, in which the square |E(ζ)|² of the modulus of the electrical field appears as follows:

$$Δ \hat{n} - \frac{{K}_{n}^{2}}{{T}^{2}} {\vert E ( ζ ) \vert}^{2} \hat{n} - \frac{1}{D} \frac{\partial \hat{n}}{\partial t} = 0 \qquad Equation 14$$

In a preferred embodiment of the invention, the space-time of diffusion in a non-uniform electrical field is deformed according to the three equations below:

$$ζ -> Ψ ( ζ ) = - \frac{{K}_{n}}{T} \int E ( ζ ) d ζ \qquad Equation 15$$

called the complex electrical potential conventionally known in electrostatics and which deforms space perpendicularly into cylindrical forms of the source and of the drain,

$$y -> Y ( ζ ) = \frac{{K}_{n}}{T} \vert E ( ζ ) \vert y \qquad Equation 16$$

which deforms space in a parallel manner to cylindrical forms of the source and of the drain,

$$t {\to }^{ } Θ ( ζ ) = \frac{{K}_{n}^{2}}{{T}^{2}} \vert E ( ζ ) {\vert}^{2} t \qquad Equation 17$$

called “Fermi time” with reference to known calculations in neutron technology, in order to end up with a three-dimensional diffusion equation for \hat{n}in a uniform electrical field, of which the very well known classical solution is applied directly. All the (Ψ,Y,Θ)s defined by equations 15, 16 and 17 are called deformed space-time or “Fermi space-time”.

In the case of the impact of a neutron in starting point ζ₀ and reference “y₀” under the drain-source channel of a transistor on date t=0, the classical solution in deformed Fermi space-time expresses the density of electrical charges created by this impact in any starting point ζ and reference “y” on date “t”. The following is obtained:

$$\begin{matrix}{n}^{⋒} ( ζ ) = \frac{1}{{( 4 π D Θ ( ζ ) )}^{3 / 2}} exp ( - \begin{matrix}\vert Ψ ( ζ ) - Ψ ( {ζ}_{0} ) {\vert}^{2} + \\ \frac{\vert Y ( ζ ) - {Y}_{0} ( {ζ}_{0} ) {\vert}^{2}}{4 D Θ ( ζ )}\end{matrix} ) \\ exp ( - D Θ ( ζ ) )\end{matrix} \qquad Equation 18$$

where D is the diffusion constant of electrical charges,

$${Y}_{0} ( {ζ}_{0} ) = \frac{{K}_{n}}{T} \vert E ( {ζ}_{0} ) \vert {y}_{0} .$$

The first exponential describes pure isotropic diffusion of charges, and the second exponential describes the drift of charges in the electrical field. Equation 18 shows that the charges fade very rapidly in a high electrical field since they are “drawn out” by this field to the highest positive potentials when electrons are concerned or are nil where holes are concerned while forming a wave of which the summit moves on the curved line of the equation:

|E(ζ)|y=|E(ζ₀)|y₀ Equation 19

according to the propagation equation:

|Ψ(ζ)−Ψ(ζ₀)|=2DΘ(ζ) Equation 20

The critical depth is that above which an incident neutron produces electrical charges collected in the region of the source and drain sufficient to cause the logic state of the transistor to flip-flop within a period less than the life τ of these charges subject to recombinations between them or with impurities of the semi-conductor. According to equations 9, 10, 15, 17 and 20, the volume sensitive to neutron interactions is defined as the elliptical domain such that ξ≦ξ_{MAX} where ξ_{MAX} is the solution of the equation in “x”:

$${e}^{x} ( 1 - {e}^{- \frac{x}{2}} ) {( sinh x )}^{2} = 2 D \frac{{K}_{n}}{T} \frac{V ( Λ )}{{Λ}^{2}} τ . \qquad Equation 21$$

The solution of this equation is accessible to spreadsheets employed in office data processing. In point of fact, it is sufficient to apply an optimization program available on any spreadsheet which, having taken as target the difference between the left-hand and right-hand member, searches for the value of “x” that makes the target equal to zero.

The value of D is 7.5 cm²·sec for holes and 30 cm²·sec for electrons, and τ varies inversely to the concentration “N” of the dopant of the semiconductor in atoms per cm³ according to the equation

$$τ ( sec ) = \frac{{10}^{9}}{N ( {cm}^{- 3} )} \qquad Equation 22$$

and the value is 10⁻¹² sec near to the drain to 10⁻⁷ sec near to the source.
The maximum depth of the domain is deduced, governed by the equation below:

$${z}_{max} = \frac{Λ}{2} sinh x \qquad Equation 23$$

Thus, at ambient temperature, it is found that the value of z_{MAX} is twenty times the grid width Λ for holes near to the source while z_{MAX} is equal to the grid width Λ for electrons near to the drain. Moreover, equations 21 and 23 show that the depth of the active zone and therefore the impact of neutrons on silicon depends on temperature, which is an advantage of the method according to the invention.

Knowing the maximum depth of the sensitive volume, a substantial improvement of the invention, as regards the calculation of critical energy, rests on equations, derived from equations 9, 10, 13, 15, 18 and 20, giving the value of the current I_{DS} in amperes between the drain and source at a depth ξ of the transistor brought about by the impact of a neutron of energy E_{N} in electron-volts (eV) in a starting point ζ₀=ξ₀+jηwith j=\sqrt{−1}. In point of fact, this point may be chosen at the boundary of the sensitive volume. From the impact of a neutron of energy E_{N} in eV in such a point, the current I_{DS} in amperes is deduced as follows, derived from equations 9, 19, 13, 15, 18 and 20:

$$\begin{matrix}{I}_{DS} = {E}_{N} \times {( 2 π )}^{3 / 2} \frac{H}{3 , 7} {( \frac{{K}_{n}}{T} )}^{3 / 2} \frac{{( {V}_{DS} )}^{5 / 2}}{{Λ}^{2}} {f}_{1} ( ξ , {ζ}_{0} ) exp ( - \frac{2 {K}_{n}}{T} {V}_{DS} Φ ( ξ , {ζ}_{0} ) ) & Equation 24 \\ {f}_{1} ( ξ , {ζ}_{0} ) = {( {cosh}^{2} ( {ξ}_{0} ) - {cos}^{2} ( {η}_{0} ) )}^{3 / 2} {( exp ( \frac{ξ - {ξ}_{0}}{2} ) - 1 )}^{3 / 2} & Equation 25 \\ Φ ( ξ , {ζ}_{0} ) = exp ( - \frac{ξ}{2} ) ( I - exp ( - \frac{ξ - {ξ}_{0}}{2} ) ) sin \frac{{η}_{0}}{2} & Equation 26\end{matrix}$$

H is a universal physical constant equal to the charge on the electron multiplied by the mobility of electrons and holes and of which an approximate value is 4.8×10⁻⁹ in farads x μm²/sec. V_{DS} is the voltage between drain and source, T the absolute temperature (° K.), Kₙ is the constant already defined, and Λ is the grid width in micrometers. By means of equations 24 to 26 and the use of a mathematical model expressing the drain-source current as a function of the drain-source voltage and the source grid voltage, the threshold is determined for the change of logic state of the transistor under the effect of an incident neutron with a known energy. According to a preferred embodiment of the invention, the mathematical model expressing the drain-source current I_{DS} as a function of the drain-source V_{DS} voltage and of the source grid voltage V_{GS} is that called the “Advanced EKV MOSFET model”:

$$\begin{matrix} {I}_{DS} = {I}_{F} - {I}_{R} & Equation 27 \\ {I}_{F} = {{I}_{S} ( ln ( 1 + exp ( \frac{{K}_{n}}{T} ( {V}_{GS} + 0 , 8367 - \sqrt{{V}_{GS} + 1 , 2867} ) ) ) )}^{2} & Equation 28 \\ {I}_{R} = {{I}_{S} ( ln ( 1 + exp ( \frac{{K}_{n}}{T} ( {V}_{GS} + 0 , 8367 - {V}_{DS} - \sqrt{{V}_{GS} + 1 , 2867} ) ) ) )}^{2} & Equation 29 \\ {I}_{S} = 6 ; 6954 \times {10}^{- 8} ( 1 + \frac{1}{2 \sqrt{{V}_{GS} + 1 , 5367 - \sqrt{{V}_{GS} + 1 , 2867}}} ) & Equation 30\end{matrix}$$

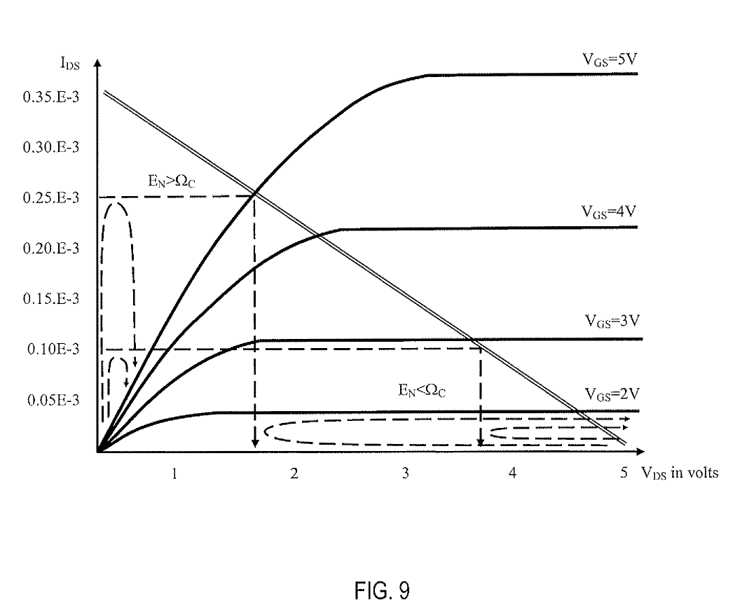

The preceding mathematical formulae can be easily employed, in particular in spreadsheets currently employed in office data processing. Equations 24 to 30 are a new basis for calculations of the critical energy E_{N}=Ω_{C} in eV based on the critical current between the drain and the source of the transistor capable causing the logic state thereof to flip-flop. The operating curves of a transistor are described in FIG. 9. These represent, as a function of the drain-source potential V_{DS} expressed in volts, variations of the drain-source intensity I_{DS} expressed in mA for various grid-source potentials expressed in volts. In FIG. 9, the charge straight line of the transistor has also been added. In order to complete the calculating protocol, the equation for this charge straight line in the region of the drain of the transistor must be joined to equations 24 to 30. Thus, as illustrated in FIG. 9, it is possible to determine the current sufficient to bring about the change of state of the transistor, that is to say transition of the “0” logic state to the “1” state. It is then possible to determine the energy E_{N} sufficient to bring about this transition.

This constitutes a novel advantage of the invention. In point of fact, it is possible to measure the impact of a neutron in a precise manner, as a function of the circuit of the drain of the transistor.

The fourth step of the simulation method consists of determining the probability of a collision between an incident neutron and a silicon nucleus as a function of the depth z under the active surface of the electronic component. The effective collision cross section of a neutron with the silicon nucleus is known in nuclear physics. The probability of the collision of an incident neutron with a silicon nucleus situated in the first elementary cell of the crystalline lattice of the semiconductor, in this case silicon, may be calculated as the ratio of the effective cross section of collision with a single nucleus to the area of the elementary cell of the crystalline network of the semiconductor, which gives 10⁻⁸. In a preferred embodiment of the invention, the effective collision cross section is calculated in millibarn (1 barn=10⁻²⁴ cm²) as a function of the energy E_{N} in MeV of the incident neutron according to a log-normal law of which the following is an illustration by way of example:

$$σ ( {E}_{N} ) = 1870 exp ( - 0 , 3689 {( ln ( \frac{{E}_{N}}{32} ) )}^{2} ) \qquad Equation 31$$

Thus, the probability of a collision depends on the energy of the incident neutron with a maximum of 1.87 barn at 32 MeV.

The probability of a given number of elastic collisions is then given by a Poisson distribution. Taking into account the number of crystal cells encountered at the depth “z”, the probability is obtained:

V̅(z)=1−exp(−K_{V}·z) Equation 25

with K_{V} a constant equal to 0.40538 from which it is possible to deduce the mean number of collisions at the depth “z” for a single neutron.

FIG. 8 represents variations in the number of critical collisions by a neutron as a function of the grid width of the transistor.

The fifth step of the method consists of calculating, in a manner applicable to spreadsheets currently employed in office data processing, the number of collisions by incident neutrons resulting from interactions between cosmic rays in the upper atmosphere per unit area and per unit time and silicon nuclei belonging to the sensitive volume of a transistor as a function of parameters calculated during the preceding steps. This number depends on:
the number of neutrons having an energy equal to or greater than the critical energy per unit area and per unit time, in the atmospheric flux;
the volume sensitive to neutron interactions in the transistor;
the probability of an incident neutron colliding with a silicon nucleus.

The final step of the method consists of calculating, in a manner applicable to spreadsheets currently employed in office data processing, the anticipated failure rate per hour as a function of:
the number of collisions of neutrons of the incident atmospheric flux per unit area and per unit time with silicon nuclei belonging to the sensitive volume;
the degree of operation of electronic components actually sensitive to neutron interactions in the equipment.

In the case of aeronautic applications, if the equipment is a piece of onboard equipment for an aircraft, said aircraft carrying out a flight of which the profile is defined by the latitudes and longitudes of the starting and arrival airports for the aircraft and by the flight altitude profile of the aircraft between said airports, the method according to the invention may include a supplementary step consisting of calculating the average failure rate as a function of said flight profile.

The equipment may then include means for detecting and correcting errors due to failures of the equipment subjected to atmospheric neutron radiation, said means being then dimensioned as a function of said failure rate.

What is claimed is:

1. A method for simulating the failure rate of electronic equipment disposed at a known latitude, longitude and altitude and subjected to atmospheric neutron radiation of natural origin, said equipment having electronic components on a silicon substrate including transistors of which the technology is determined by a known grid width, the said method comprising the following steps:
Calculating the number of incident atmospheric neutrons per unit area and per unit time as a function of the altitude, latitude and longitude within a given energy spectrum;
Calculating the critical energy of a neutron sufficient to create a critical charge capable of changing the state of a transistor, said energy being a function of the grid width and depth under the active surface of the electronic component;
Calculating the sensitive volume of a transistor within which a neutron having an energy equal to or greater than the critical energy may create said critical charge;
Calculating the probability of an incident neutron colliding with a silicon nucleus as a function of the depth under the active surface of the electronic component;
Calculating the probability of the collision of an incident neutron per unit area and per unit time with a silicon nucleus belonging to the sensitive volume of a transistor as a function of:
the number of neutrons having an energy equal to or greater than the critical energy;
the ratio of the sensitive volume to the total volume of the transistor;
the probability of a an incident neutron colliding with a silicon nucleus;
Calculating the projected failure rate per hour as a function of:
the probability of an incident neutron colliding per unit area and per unit time with a silicon nucleus belonging to the sensitive volume;
the number of electronic components.

2. The method for simulating the failure rate as claimed in claim 1, wherein the number of incident atmospheric neutrons per unit area and per unit time is equal to the product:
of a first constant;
of a first exponential function of which the exponent depends on latitude and longitude;
of a second exponential function of which the exponent depends on altitude;
of a difference between two error functions, functions of the boundaries of the energy spectrum.

3. The method for simulating the failure rate as claimed in claim 2, wherein the second exponential function of which the exponent depends on the altitude A is of the Weibull law type, the exponent varying as a function of altitude according to the expression:
$${( \frac{{K}_{A} - A}{{{K}_{A}}^{′}} )}^{{{K}_{A}}^{′′}}$$
with K_{A}, K_{A}′ and K_{A}″ being the second, third and fourth constants.

4. The method for simulating the failure rate as claimed in claim 1, wherein the critical energy of a neutron is equal to the ratio between:
the product of a fifth constant multiplied by the blocking voltage multiplied by the critical charge;
an exponential function depending on the depth under the active surface of the electronic component.

5. The method for simulating the failure rate as claimed in claim 4, wherein the blocking voltage is a second degree polynomial that is a function of the grid width.

6. The method for simulating the failure rate as claimed in claim 4, wherein the critical charge is an exponential function dependent on the grid width.

7. The method for simulating the failure rate as claimed in claim 1, wherein the critical energy of a neutron is such that it produces electrical charges collected in the region of the source and of the drain sufficient to cause the logic state of the transistor to flip-flop within a period less than the life τ of these charges.

8. The method for simulating the failure rate as claimed in claim 1, wherein the sensitive volume is the volume in which the modulus of the electrical field due to the drain-source potential of the transistor is such that the electrical field may ensure the transport of electronic charges created by the impact of a neutron.

9. The method for simulating the failure rate as claimed in claim 1, wherein the geometrical forms of the source and of the drain of the transistor match those of hyperbolic cylinders so that they can be represented with the aid of the transformation according to:
$$χ = x + jz = \frac{Λ}{2} ( 1 + cosh ( ξ + jη ) ) j = \sqrt{- 1}$$
where x is the distance at the plane of the transistor source, z the depth under the active surface of the electronic component and Λ the grid width on the one hand and ξ and η being the elliptical coordinates, on the other hand, the geometrical forms of the source and drain being described by the equations η=cons tan te<π/2 (drain)>π/2 (source).

10. The method for simulating the failure rate as claimed in claims 8 and 9, wherein the modulus of the electrical field as a function of the blocking voltage V, of the distance x to the plane of the source of the transistor, of the depth z under the active surface of the electronic component and the grid width Λ has the following expression
$$\vert E ( ζ ) \vert = \frac{V ( Λ )}{Λ} \cdot \vert \frac{exp ( - \frac{ζ}{2} )}{sinh ζ} \vert$$
in which the complex variable ζ is defined from elliptical coordinates (ξ, η) with ζ=ξ+jη and j=\sqrt{−1} and in which the standard transformation making it possible to pass from Cartesian coordinates (x,z) to elliptical coordinates
$$( ξ , η ) is written χ = x + jz = \frac{Λ}{2} ( 1 + cosh ζ ) .$$

11. The method for simulating failure rate as claimed in claim 10, wherein the volume sensitive to neutron interactions is defined as the elliptical domain where ξ is less than ξ_{MAX} where ξ_{MAX} is the solution of the equation:
$${e}^{{ξ}_{MAX}} ( 1 - {e}^{- \frac{{ξ}_{MAX}}{2}} ) {( sinh {ξ}_{MAX} )}^{2} = 2 D \frac{{K}_{n}}{T} \frac{V ( Λ )}{{Λ}^{2}} τ$$
in which T is the absolute temperature, Kₙ the universal physical constant equal to the electron charge divided by twice the Boltzmann constant, D the diffusion constant of electrical charges and τ the life of the charges created by neutron impact.

12. The method for simulating failure rate as claimed in claim 10, wherein the sensitive volume has a maximum depth z_{MAX} equal to
$$\frac{Λ}{2} sinh {ξ}_{MAX} .$$

13. The method for simulating failure rate as claimed in claim 1, wherein the equipment being onboard equipment for an aircraft, said aircraft performing a flight of which the profile is defined by the latitudes and longitudes of the starting and arrival airports and by the altitude profile of the flight between said airports, the method includes a supplementary step consisting of calculating the mean failure rate as a function of said flight profile.

14. The method for simulating failure rate as claimed in claim 1, the said method being put into operation by means of a spreadsheet of the office data processing type.

15. Electronic equipment for aircraft, including means for detecting and correcting errors due to failures of the equipment subjected to atmospheric neutron radiation, said means being dimensioned as a function of said failure rate calculated by means of a method as claimed in claim 13.

16. The method for simulating failure rate as claimed in claim 13, the said method being put into operation by means of a spreadsheet of the office data processing type.
